(19) United States
(12) Patent Application Publication
(10) Pub. No.: US 2012/0226519 A1
(43) Pub. Date: Sep. 6, 2012

(54) METHODS AND SYSTEMS FOR DETERMINING RISK ASSOCIATED WITH A REQUIREMENTS DOCUMENT

(75) Inventor: Shannon L. Copeland, Atlanta, GA (US)

(73) Assignee: Kilpatrick, Stockton & Townsend LLP, Atlanta, GA (US)

(21) Appl. No.: 13/410,414

(22) Filed: Mar. 2, 2012

Related U.S. Application Data
(60) Provisional application No. 61/448,456, filed on Mar. 2, 2011.

(51) Int. Cl. G06Q 10/00

(52) U.S. Cl. 705/7.28

(57) ABSTRACT

Systems and methods are provided for assessing a risk associated with a requirements document and/or identifying one or more resources that can be used to manage the risk. A requirements document can be analyzed to extract elements from the requirements document into relationships. A relationship interface can be generated that includes the relationships for the requirements document. Information, associated with an entity or otherwise, relevant to the requirements document can be organized into risk issues using the relationships interface. One or more resources may be identified for the information relevant to the requirements document and an interface can be provided between the identified resource and a manager of the requirements document.

### CROSS-REFERENCE TO RELATED APPLICATIONS

This application claims priority to U.S. Provisional Application No. 61/448,456, filed Mar. 2, 2011 and titled “Methods and Systems for Determining Risk Associated with a Contract,” the entirety of which is incorporated herein by reference.

### FIELD

This disclosure relates generally to computer hardware and software for assessing risks associated with a requirements document, that runs, displays, provides, or otherwise uses electronic content and more particularly (although not necessarily exclusively) to computer software for determining risks and/or identifying one or more resources for managing same.

### BACKGROUND

Examples of requirements documents include among others contracts, policies, laws and government or authority regulations, project plans, configuration documents, checklists, recipes, ingredients or formulas such as those used in defining what the components of a substance or product should contain, or what components should be present in a warning label or advertising message, organizational initiatives and scenario, a rule, set of rules or key performance indicators (KPI) monitoring whereby a manager defines scenarios, KPIs or situations that should be identified as they occur within an company, organization, government or an entity that produces or has produced a dataset that can be monitored for such scenarios. Requirements documents are complex because they are often lengthy documents written in legal, formal and/or technical language that is difficult for non-specialist, non-experts and non-lawyers to understand, translate, monitor and verify. This problem becomes more apparent, intense and important as the requirements document becomes more sophisticated, larger and more technical in scope. Technicalities can emerge in any industry, such as finance, pharmaceuticals, building construction or tunnel construction.

Furthermore, the requirements, triggers and interdependencies in the document may not be easily monitored and compared to the actual results of the execution with respect to the requirements document. Finally, many large complex requirements documents are interdependent with other requirements documents. For example, a requirements document between a municipality, such as Miami, and a contractor to build a new performing arts center may be referenced and become interdependent with requirements documents between the primary contractor and the contractors, as well as with the financial institutions that invest in the project.

Because a requirements document may contain penalties for failure to properly execute a requirement (e.g., the bridge is not built by the defined deadline) or simply elements specifying costs and payments to be incurred by the parities involved if a predicted scenario does not occur (e.g., a stock price does not rise or fall as anticipated), the risks to any party involved in the requirements document are not easily understood nor monitored or managed for all the same reasons described above.

To assess an estimate of the risk of a party, expensive resources, such as attorneys, consultants, and accountants, may be employed. Such processes can be undesirable because of, among others, cost, inefficiencies, inaccuracies, and inability to identify the best resource for a particular issue or risk assessment. Given the enormous and growing volume of electronically stored information that within, for example, a corporation, municipality or project associated with the execution of a requirements document, human resources, regardless of expertise, may be unable to monitor compliance accurately.

Accordingly, systems and methods are desirable that can better assess risk associated with a requirements document. Systems and methods are also desirable that can identify one or more resources that can be useful for managing the risk.

### SUMMARY

Certain aspects and embodiments relate to assessing a risk associated with a requirements document and/or identifying one or more resources that can be used to manage the risk.

One aspect relates to a method in which relationships for a requirements document are generated by a computing device by analyzing elements of the requirements document and risks associated with the elements. A relationship interface is generated by the computing device. The relationship interface includes the relationships for the requirements document. Information relevant to the requirements document, but separate from the requirements document, is organized by the computing device into risk issues using the relationships interface.

Another aspect relates to a system that includes a processor device and a tangible medium embodiment code. The code can be executable by the processor to cause the system to perform actions. The actions can include generating relationships for a requirements document by analyzing elements of the requirements document and risks associated with the elements, generating a relationship interface that comprises the relationships for the requirements document, and organizing information relevant to the requirements document, but separate from the requirements document, into risk issues using the relationships interface.

Another aspect relates to a tangible computer-readable medium that includes program code that is executable by a processor to perform actions. The program code includes code for extracting elements of a requirements document. The program code also includes code for relating at least some of the extracted elements together based on a meaning of the extracted elements to generate relationships between some of the extracted elements. The program code also includes code for storing the extracted elements and the relationships.

These illustrative aspects are mentioned not to limit or define the invention, but to provide examples to aid understanding of the inventive concepts disclosed herein. Other aspects, advantages, and features of the present invention will become apparent after review of the entire disclosure.

### BRIEF DESCRIPTION OF THE FIGURES

FIG. 1 is a block diagram of a system for determining risk of a requirements document and for identifying one or more resources for managing the risk according to one embodiment.

FIG. 2 is a flow chart of a method for assessing risk of a requirements document and for identifying one or more resources for managing the risk according to one embodiment.

FIG. 3 is a flow chart of a method for assessing risk of a requirements document according to one embodiment.

FIG. 4 is a flow chart of a method for calculating risk exposure values and/or index values based on one or more comparisons according to one embodiment.

FIG. 5 is a flow chart of a method for creating a future scenario for a variance impact according to one embodiment.

FIG. 6 is a flow chart of a method for using risk and requirements document elements to identify one or more resources according to one embodiment.

FIG. 7 is a flow chart of a method for providing an interface between one or more resources and a requirements document manager according to one embodiment.

FIG. 8 is a screen face illustrating an example of information relevant to a requirements document and a relationship interface according to one embodiment.

### DETAILED DESCRIPTION

Certain features of the present disclosure include systems and methods for assessing a risk associated with a requirements document and/or identifying one or more resources that can be used to manage the risk. In some embodiments, a requirements document can be analyzed to extract elements from the requirements document into relationships. A relationship interface can be generated that includes the relationships for the requirements document. Information, associated with an entity or otherwise, relevant to the requirements document can be organized into risk issues using the relationships interface. In some embodiments, one or more resources can be identified for the information relevant to the requirements document and an interface can be provided between the identified resource and a manager of the requirements document.

Elements may be any item in or about a requirements document. Examples of elements include terms, conditions, promises, requirements, tasks, goals, consequences, damages, names of parties, location identifiers, scope of work, deadlines, etc.

Relationships may be relationships between meanings of one or more elements in the requirements document. Examples of relationships include an association between damages and delay of task performance or non-performance. Another example can include establishing the relationship between non-compliance and a warning label that is missing a word. In some embodiments, the relationships may be semantic relationships.

A relationship interface may be a computer-generated interface that includes identifiers for risk issues and other content about a requirements document. An example of a relationship interface is a list of identifiers in a taxonomy that also visually represents relationships between identifiers. For example, specific issues (e.g. overall project delay, acquisition of materials for project delay, etc.) can be related to a general issue (e.g. delays) and the relationship can be visually represented by the relationship interface. In some embodiments, a relationship interface can represent a triplestore (e.g. database of triples). Risk issues may be potential issues (e.g. consequences, damages, problems) that may arise in the context of performing obligations, duties, goals, etc. set forth in the requirements document.

Information relevant to the requirements document may be any information separate from the requirements document, but related to at least one element of the requirements document. Examples of information include content of email, correspondence, or documentation about performance associated with the requirements document. For example, information relevant to the requirements document may be content of an email that is processed by a server for an entity or individual that is a party to the requirements document.

Information relevant to the requirements document can be organized into risk issues automatically or manually using the relationships interface. For example, content of an email can be automatically analyzed and compared to the relationships interface to determine if any of the content is relevant to one or more risk issues. If certain content is relevant, the content (or otherwise the entire email) can be associated automatically to one or more appropriate risk issues. Additionally or alternatively, a system according to some embodiments can receive from a subject matter expert or other individual an association of certain content or the entire email to one or more risk issues.

In some embodiments, a requirements document is compared to standards, templates (e.g. International Federal of Consulting Engineers (FIDIC) and American Institute of Architects (AIA)), or prior requirements documents to extract elements of the requirements document and determine the meaning of the elements. For example, a clause or word combination in a requirements document can be identified as the type of language in a type of FIDIC requirements document. In other examples, a library or ontology of related words and concepts can be used to determine paragraph and sentence level meaning within a requirements document. The meaning for elements of the requirements document can be combined with technical requirements, such as numbers, timelines, deadlines, etc., in the requirements document and associated with external data that reflects actual performance of tasks, or otherwise, under the requirements document. External data can include actual results being achieved with respect to the requirements documents requirements.

In some embodiments, the requirements document elements can be used to (1) assess a risk for a party to, or associated with, the requirements document and/or (2) identify one or more resources useful in managing the risk. A resource can be a tool or person that can help in managing a particular type of risk. Examples of resources include databases, other requirements document managers, software applications, organizations, and attorneys. After one or more resources are identified, the interface can be provided between a requirements document manager (or other relevant personnel) and a resource to facilitate risk management and resolution.

These illustrative examples are given to introduce the reader to the general subject matter discussed here and are not intended to limit the scope of any claim. The following sections describe various additional embodiments and examples with reference to the drawings in which like numerals indicate like elements.

### Illustrative System Implementation

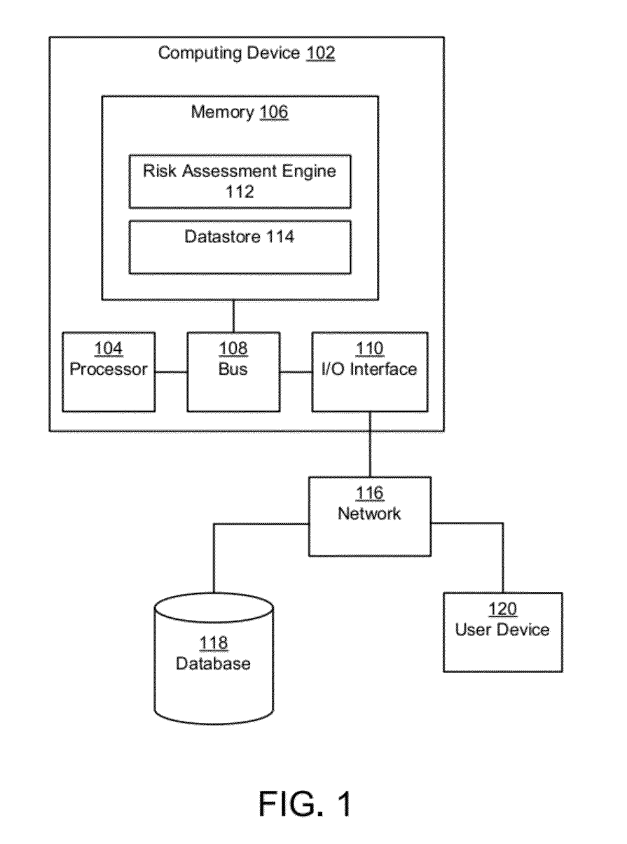

FIG. 1 depicts a system that is configured for assessing risk associated with a requirements document, organizing information based on risk issues, identifying one or more resources to help manage risk, and/or provide an interface between relevant personnel and the resource, according to certain embodiments. Other embodiments may be utilized. The system includes a computing device 102 having a processor 104 that can execute code stored on a tangible computer-readable medium, such as a memory 106, to cause the computing device 102 to perform processes as described more fully herein. The computing device 102 may be any device that can process data and execute code that is a set of instructions to perform actions. Examples of the computing device 102 include a database server, a web server, desktop personal computer, a laptop personal computer, a server device, a handheld computing device, and a mobile device.

Examples of the processor 104 include a microprocessor, an application-specific integrated circuit (ASIC), a state machine, or other suitable processor. The processor 104 may include one processor or any number of processors. The processor 104 can access code stored in the memory 106 via a bus 108. The memory 106 may be any non-transitory computer-readable medium configured for tangibly embodying code and can include electronic, magnetic, or optical devices. Examples of the memory 106 include random access memory (RAM), read-only memory (ROM), a floppy disk, compact disc, digital video device, magnetic disk, an ASIC, a configured processor, or other storage device. The bus 108 may be any device capable of transferring data between components of the computing device 102. The bus 108 can include one device or multiple devices.

Instructions can be stored in the memory 106 as executable code. The instructions can include processor-specific instructions generated by a compiler and/or an interpreter from code written in any suitable computer-programming language, such as C, C++, C#, Visual Basic, Java, Python, Perl, JavaScript, and ActionScript. The instructions can include a database server application, such as risk assessment engine 112, that, when executed by the processor 104, can cause the computing device 102 to perform processes according to embodiments as explained in more detail below.

Memory 106 can also include a datastore 114. The datastore 114 may be a relational database, a flat-file database, triplestore, or other data storage device. In other embodiments, the datastore 114 is separate from the computing device 102 but in communication with the computing device 102 through an input/output (I/O) interface 110.

The computing device 102 can share data with additional components through the I/O interface 110. The I/O interface 110 can include a USB port, an Ethernet port, a serial bus interface, a parallel bus interface, a wireless connection interface, or any suitable interface capable of allowing data transfers between the computing device and another component. The additional components can communicate with I/O interface 110 over a network 116. The network 116 can include the internet, an intranet, wide area network (WAN), local area network (LAN), virtual private network (VPN), or any suitable communications network that allows computing device 102 to communicate with other components. Network 116 may include one or more networks.

The additional components can include a database 118 and a user device 120. The database 118 may be remote from the computing device 102. In some embodiments, the database 118 can store various types of information as explained more fully below. The user device 120 can include a second computing device, such as a laptop or personal computer that is configured for processing commands to output a user interface to a display. In some embodiments, the user device 120 is a display device that is coupled to the computing device 102 directly instead of over the network 116.

This exemplary system configuration is provided to illustrate configurations of certain embodiments. Other configurations and embodiments may of course be utilized.

### Exemplary Methods of Requirements Document Risk Assessment and Organization

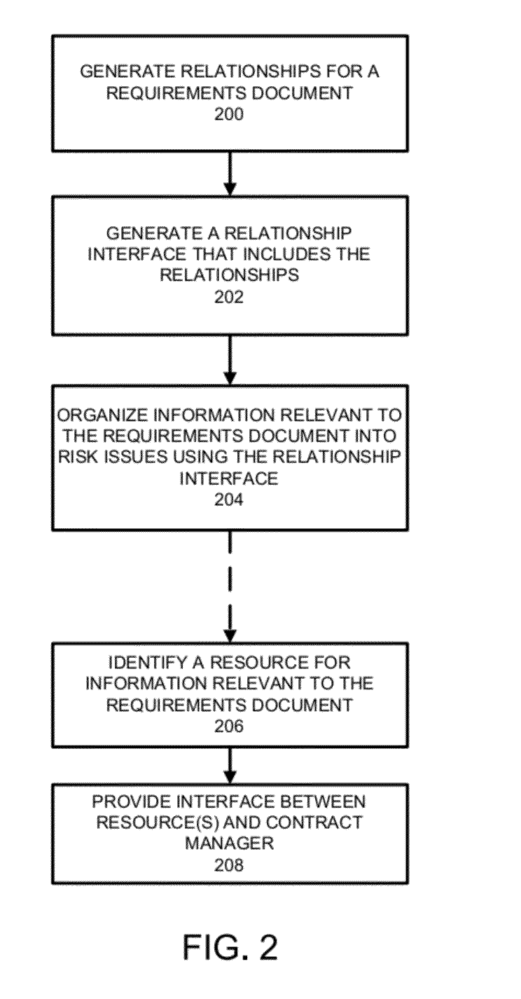

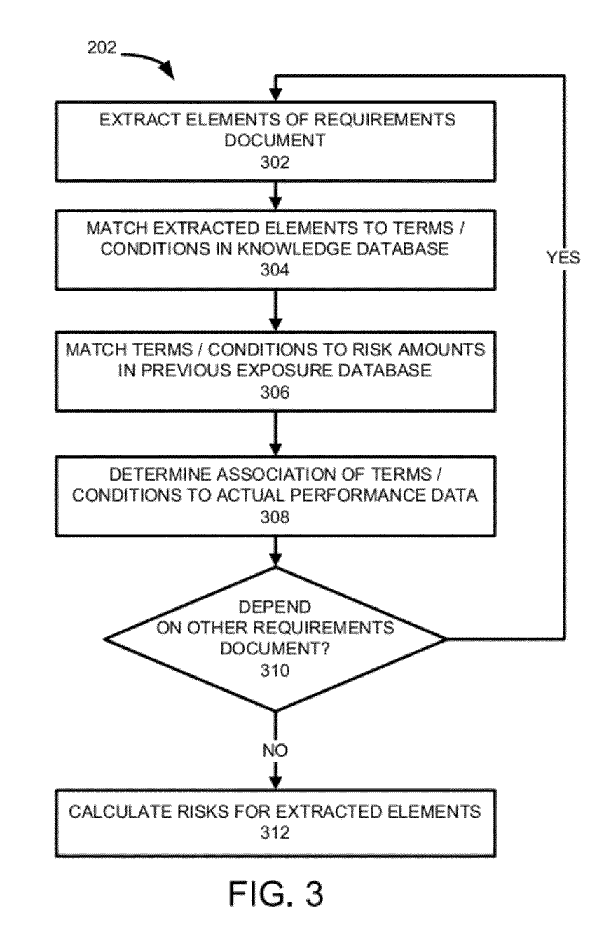

FIG. 2 is a flow diagram that depicts an overall process for assessing requirements document risk according to certain embodiments of the present invention. The process is described with reference to the system implementation shown in FIG. 1 and process flows depicted in FIGS. 3-8. Other implementations and processes, however, are possible.

In block 200, the risk assessment engine 112 generates relationships for a requirements document. In some embodiments, the risk assessment engine 112 extracts requirements document elements and analyzes the elements to identify the party that bears the risk for a particular element and the type of risk.

A relationship can associate a risk to an element or an element to another element. In some embodiments, the risk assessment engine 112 may compare the elements to stored data, such as stored historical data of requirements document terms and performance information of prior requirements documents that are similar to the requirements document, to determine a risk or risks associated with a requirements document for a party.

In block 202, the risk assessment engine 112 generates a relationship interface that includes the relationships. The relationship interface may visually depict a list of risk issues by element or type of risk.

In block 204, the risk assessment engine 112 organizes information relevant to the requirements document into risk issues using the relationship interface. In some embodiments, the risk assessment engine 112 automatically and analyzes content of correspondence or communication of an entity and associates the correspondence or communication to the relevant risk issue based on the analysis. In other embodiments, the risk assessment engine 112 receives an association for the correspondence or communication to one or more risk issues and organizes the correspondence or communication based on the association.

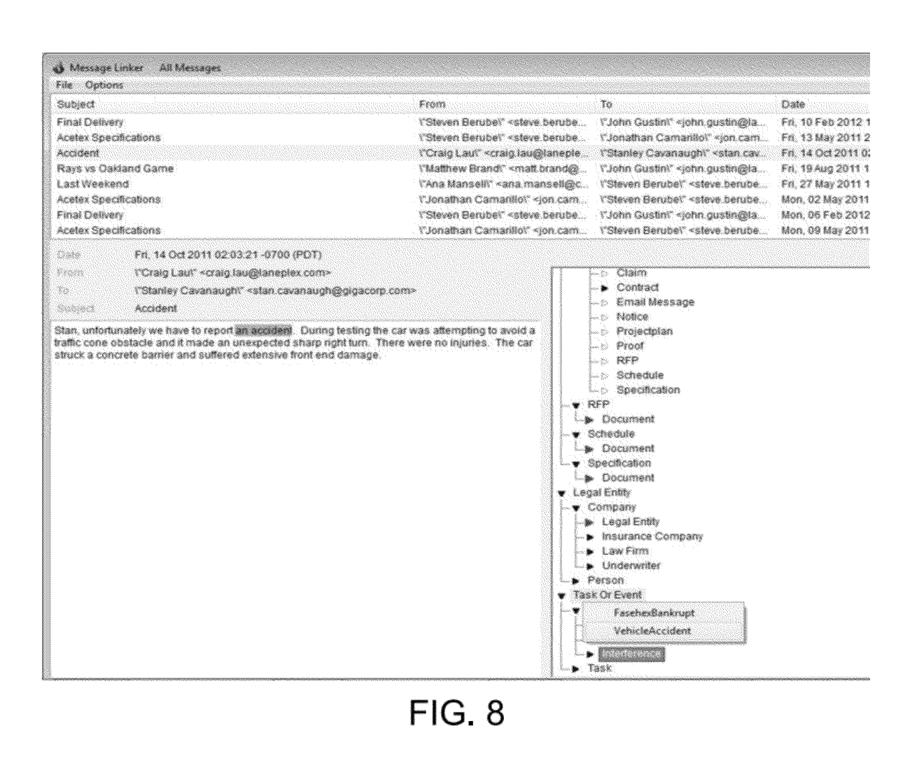

FIG. 8 is a screen face depicting an example of a workflow usable for organizing information using a relationship interface. The screen face depicts an email that includes information relevant to a requirements document. A relationship interface developed based on the requirements document is partially shown on the right-hand side with the email program. The relationship interface depicts risk issues and other items for the requirements documents in a taxonomy or “tree-like” visual representation. Examples shown include RFP (request for proposal), schedule, specification, legal entity, task or event and task. Under the task or event, additional issues are listed, including “VehicleAccident.” The words “an accident” in the email message are highlighted. Highlighting can designate content in an email message that is relevant to the requirements document and to a risk issue in the relationship interface. Words or phrases in an email can be highlighted automatically or by a user, such as a subject matter expert. The highlighted words can be associated automatically or manually to an issue on the relationship interface. In this example, words are associated with “VehicleAccident.” Associating with the listed issue can cause the email to be associated with the issue and allowed to be accessed later using the relationship interface.

Information organized using the relationship interface can be used for many purposes. Examples of purposes include identifying one or more resources to resolve or manage risk for the information and providing an audit trail for issues associated with the requirements document. Blocks 206 and 208 of FIG. 2 depict one process for identifying a resource to resolve or manage the risk.

In block 206, the risk assessment engine 112 identifies one or more resources for the information relevant to the requirements document. In some embodiments, the risk assessment engine 112 analyzes data in datastore 114 or database 118 that includes an identification of available resources and the types of risks that each resource can be used manage, and compares the information to the type of risk to which the information is associated via the relationship interface. For example, the data can include a particular type of risk and an identification of a requirements document manager that has handled or otherwise has experience in the particular type of risk.

In block 208, the risk assessment engine 112 provides an interface between one or more resources and the requirements document manager or other personnel managing the requirements document. The interface may be a communication portal generated using web-based technology, or otherwise, that allows the requirements document manager to communicate with a resource (if the resource is a person) or to access a resource (if the resource is a management tool, such as a software application). The communication portal may allow real-time communication between the requirements document manager and the resource. The requirements document manager can use the resource to resolve the risk or otherwise reduce the risk exposure.

FIG. 3 depicts one example of a process for generating relationships by determining elements and associated risks for a requirements document in accordance with block 202 in FIG. 2. In block 302, the risk assessment engine 112 imports and extracts requirements document elements. The risk assessment engine 112 can import a requirements document and related information by receiving an electronic version of the requirements document and related information electronically from any source so that the requirements document and related information can be read, recognized, analyzed and connected to external data, such as data not contained in the requirements document. The requirements document and related information can include words, attachments, drawings, and appendices. The risk assessment engine 112 can extract elements of the requirements document by recognizing words and terms in the requirements document that may indicate or describe requirements and duties associated with the requirements document. In some embodiments, the risk assessment engine 112 extracts requirements document elements by determining that a requirements document is a certain type of requirements document by comparing requirements document terms and phraseology to a database that includes requirements document types and associated terms and phraseology. After identifying the type of requirements document, the risk assessment engine 112 can use information about the type of requirements document and its terms to determine the elements in the requirements document.

Extracted elements from a requirements document can be used in some embodiments for accurately searching a database for indications with compliance with terms and/or conditions, for example using relationships between elements in the relationship interface or otherwise relationships between the extracted elements and terms and/or conditions that are based on a semantic library of terms. Furthermore, extracted elements stored in a database can be queried using natural language queries and other search methods. Automatically extracted elements and determining element meaning may provide cost effective detection, monitoring, and risk mitigation possible across document enterprise-wide.

In block 304, the risk assessment engine 112 matches extracted elements to terms and/or conditions in a knowledge database. For example, the knowledge database, which may be database 118, can include data such as regulatory data and standard requirements document (e.g. template) data that include information about terms of the requirements document type that is the requirements document. The information can be used by the risk assessment engine 112 to determine the party at risk for a particular element and, for some elements, to determine the amount of risk for the element. For other elements, the information may be unable to be used to determine the precise amount of risk for the particular element.

In block 306, the risk assessment engine 112 matches terms and/or conditions to risk amounts in a previous exposure database to identify one or more risk amounts for the terms and/or conditions. The previous exposure database, which may be database 118 or another database in communication with the computing device 102, can include data such as financial and accounting data, company (i.e. commercial) data, historical projects data, historical requirements documents data, and public legal case data. Historical projects data can include data about past and completed projects in which a party to the present requirements document participated or past and completed projects of a similar type as the project that is the subject of the present requirements document. Examples of historical projects data include delay costs and penalties for ninety day delay in constructing a crane, a contractor, “abc company”, submitted claims in excess of 25% of their original requirements document value for ten similar projects in similar regions (e.g., emerging market), a material supplier “xyz corporation” supplied 4% faulty components for a similar requirements document to construct compressor engine components, and customs officials in Brazil delayed product import certificates by 35% for oil and gas related construction projects and by 10% for fast moving consumer goods related requirements documents.

In block 308, the risk assessment engine 112 determines an association of terms and/or conditions to actual performance data. Actual performance data may be stored in a database, such as database 118, and can include data about the actual performance of tasks for the present requirements document and actual performance of similar requirements documents for similar projects as identified in block 306.

In block 310, the risk assessment engine 112, determines if the requirements document depends on other requirements documents. For example, the requirements document may have dependency with other requirements documents, such as by explicit reference to one or more other requirements documents. In some embodiments, the risk assessment engine 112 determines, by analyzing requirements documents in datastore 114 or database 118, relationship between requirements documents based on terms of the requirements documents. For example, the risk assessment engine 112 can identify a group of requirements documents as being associated with a particular project by analyzing elements of the requirements document and identifying the project in each requirements document. In other embodiments, the risk assessment engine 112 receives a dependency notation from a user.

If the risk assessment engine 112 determines that the requirements document depends on another requirements document, the process returns to block 302 for the risk assessment engine 112 to extract elements of the depended on requirements document and analyze the extracted elements.

If the risk assessment engine 112 determines that the requirements document does not depend on another requirements document, of if all depended on requirements documents have been analyzed, the risk assessment engine 112, in block 312, calculates risk exposure values and/or index values based on one or more of the comparisons in blocks 304-308.

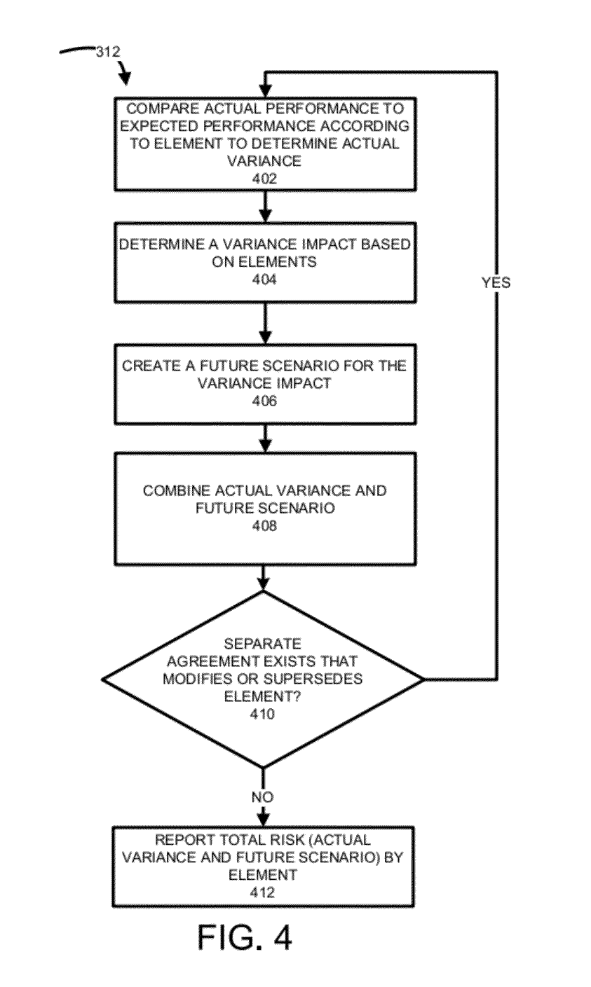

FIG. 4 depicts one embodiment of a process for calculating risk exposure values and/or index values. In block 402, the risk assessment engine 112 compares actual performance to expected performance according to an element to determine actual variance. Actual performance may be obtained based on real-time or non real-time data and may be based on financial and accounting data. Expected performance can be determined by the risk assessment engine 112 from the requirements document element. Actual variance may be the difference between expected performance and actual performance.

In block 404, the risk assessment engine 112 determines a variance impact based on requirements document elements. A variance impact can include the effect that a variance may have on additional elements of a requirements document and/or the liability of one or more parties to the requirements document.

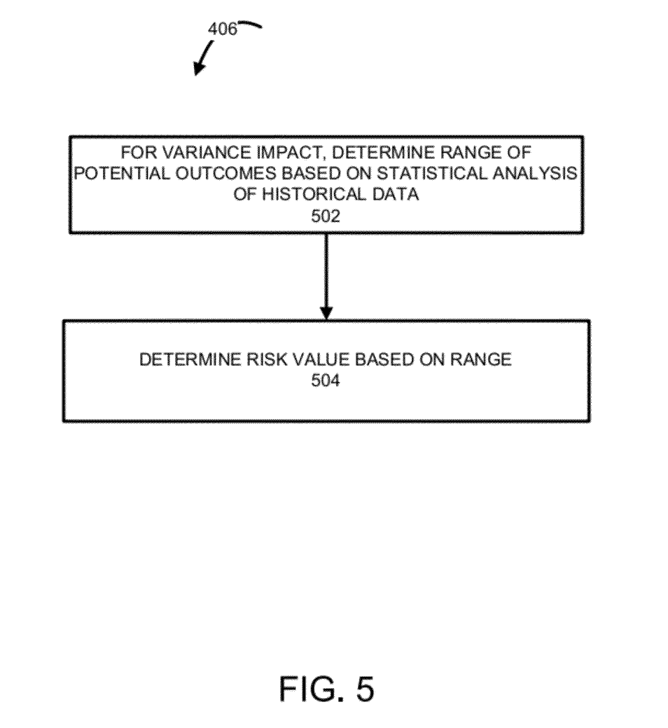

In block 406, the risk assessment engine 112 creates one or more future scenarios for the variance impact. A future scenario can include potential variances that may result of the variance impact and can be generated based on historical data about similar requirements documents with similar variance impacts, or otherwise. For example, similar requirements documents that experienced similar variances may also include similar variances that resulted from the similar actual variance. FIG. 5 depicts a process according to one embodiment for creating future scenarios.

In block 502, for each variance impact, the risk assessment engine 112 determines a range of potential outcomes based on statistical analysis of historical data. Examples of variance impacts include delay time in construction and stock price in financial services. Examples of statistical analysis can include Monte Carlo simulation.

In block 504, the risk assessment engine 112 determines a risk value for the future scenario based on the range. For example, the risk assessment engine 112 can search data sources using attributes of elements extracted from the requirements document or variance impacts to identify similar requirements documents. The risk assessment engine 112 may be configured to use only those requirements documents that are similar to a certain confidence level. The risk value can be determined based on similar risks experienced in similar requirements documents.

Returning to FIG. 4, in block 408 the risk assessment engine 112 combines the actual variance and the future scenario(s) to formulate a preliminary total risk.

In block 410, the risk assessment engine 112 determines if a separate agreement exists that modifies or supersedes an original requirements document element. In some embodiments, the risk assessment engine 112 automatically analyzes stored requirements documents associated with the project to analyze the elements of such stored requirements documents to determine if an element modifies or supersedes and element of the original requirements document. In other embodiments, the risk assessment engine 112 receives a user input identifying a modifying agreement and/or an identification of the original requirements document element that has been modified or superseded. If the risk assessment engine 112 determines that such separate agreement exists, the process returns to block 402 to re-analyze the actual performance data in view of the modifications.

If no separate agreement exists, the risk assessment engine 112 reports total risk (actual variance and future scenario(s)) by element in block 412. The risk assessment engine 112 can report the total risk by outputting a user interface with total risk data in a desired format.

### Resource Identification

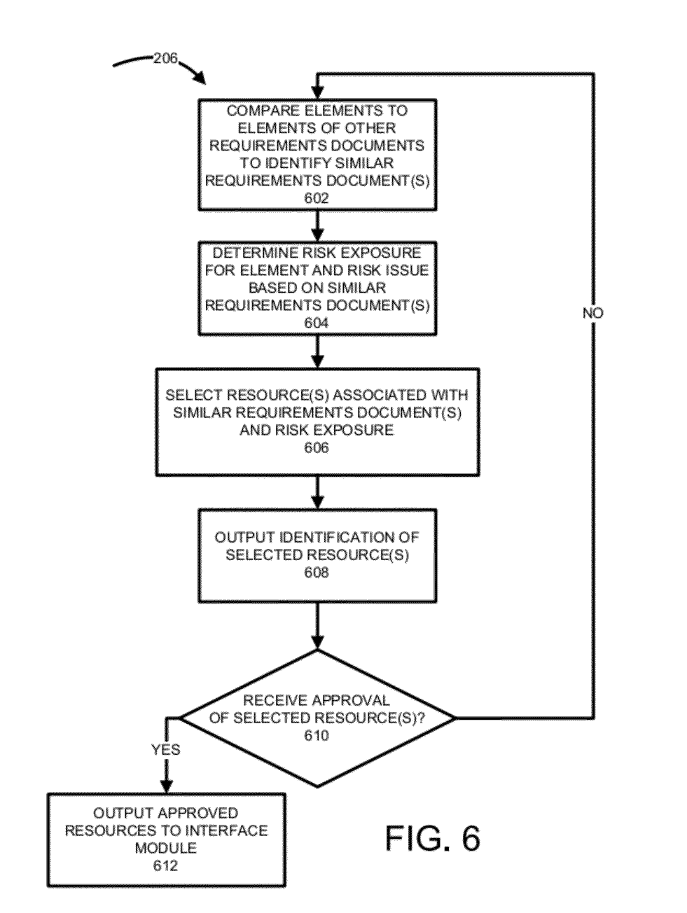

Certain embodiments provide for identification of one or more resources based on requirements document elements and in accordance with any suitable process. FIG. 6 depicts an embodiment of one process. In block 602, the risk assessment engine 112 compares requirements document elements to elements of requirements documents in a database to identify one or more similar requirements documents. This process may be similar to those discussed previously for assessing risks. In some embodiments, the step is skipped and the similar requirements documents are used as identified in accordance with the earlier processes. In other embodiments, a network or pool of resources from various providers and associated with various requirements documents may be stored in a data storage, such as data store 114 or database 118, and is separate from the risk assessment data sources. Examples of such network, or pool of resources, include requirements document owners or managers that managed or are managing similar requirements documents with similar elements, project types (e.g. rail constructions, stock transactions, bond transactions, real estate transactions), geography, and party types.

In block 604, the risk assessment engine 112 determines a risk exposure for the element and the risk issue based on the similar requirements documents. For example, the risk assessment engine 112 may identify those similar requirements documents that included a similar risk exposure at the same point in time as the present requirements document, but that the liability or other risk measurement decreased as events in the requirements document progressed. Such analysis can, for example, identify those previous requirements documents in which the same risk as experienced in the present requirements document was managed successfully.

In block 606, the risk assessment engine 112 selects one or more resources associated with similar requirements documents with similar risk ranges and that were successful in decreasing the risk over time. Examples of a resource include human and technological. A resource can be selected by, for example, identifying a resource that successfully mitigated or eliminated a similar risk associated with one or more of the similar requirements documents.

In block 608, the risk assessment engine 112 outputs an identification of one or more selected resources. Selected resources may be those resources selected by the risk assessment engine 112 as having the most potential to assist in managing risk. The risk assessment engine 112 can be configured to output a display that identifies the selected resources to a user via a display on user device 120, or otherwise.

In block 610, the risk assessment engine 112 receives approval of one or more of the selected resources. In some embodiments, the risk assessment engine 112 receives a user command that identifies one or more selected resources displayed as being approved by the user. In other embodiments, no approval process is necessary.

In block 612, the risk assessment engine 112 outputs approved resources to an interface module. The interface module may be a component of the risk assessment engine that manages an interface between a user, such as a requirements document manager, and a resource.

### Resource Interface

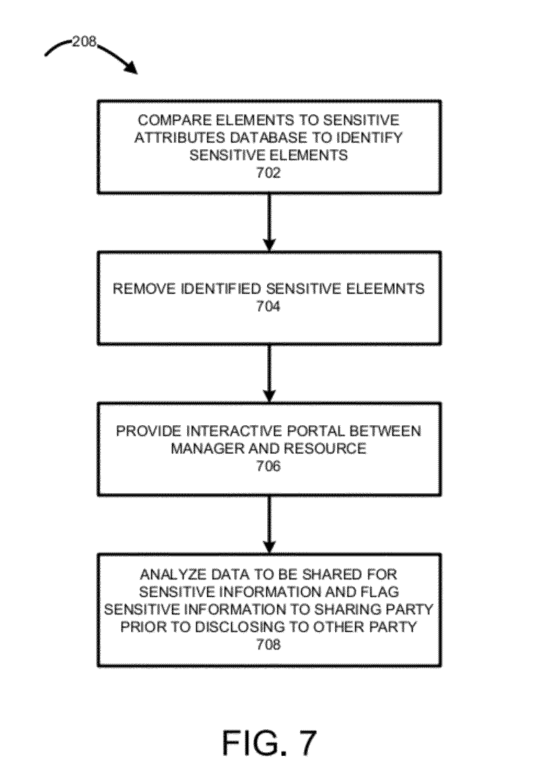

Certain embodiments can be used to provide an interface between a user that is a requirements document manager and a resource that provides additional communication security. The interface can be used to exchange information. FIG. 7 depicts one embodiment of a process for providing an interface. In block 702, the risk assessment engine 112 compares elements to a sensitive attributes database to identify sensitive elements. The sensitive information database, which may be in datastore 114 or in database 118, can include a list of requirements document attributes or elements that cannot be shared to entities or persons that are not parties to the requirements document. Examples of sensitive information include company names, cities, project names, party names, investors, individual person names and contract amounts. The risk assessment engine 112 can identify sensitive elements by finding a match of the attribute in the sensitive information. In some embodiments, the risk assessment engine 112 determines that a particular attribute or element, while not matching sensitive information, may be sensitive information because it is an abnormal word, phrase, or number to standard requirements documents of the same type. The flag can be outputted to a user for review and confirmation of sensitivity.

In block 704, the risk assessment engine 112 removes identified sensitive elements. The risk assessment engine 112 can be configured to automatically redact or otherwise delete sensitive elements in a requirements document or otherwise that may be shared with a resource.

In block 706, the risk assessment engine 112 provides an interactive portal between the requirements document manager and a resource. The interactive portal may be a web-based interface that allows, in real-time, data sharing and communication. Examples of interactive portal functionality can include instant messaging, video conferencing, and document sharing applications.

In block 708, the risk assessment engine 112 analyzes data to be shared for sensitive information and flags sensitive information to a sharing party prior to disclosing to the other party. Prior to allowing a message to be transmitted to the resource from the user, or to the user from the resource, the risk assessment engine 112 can compare the content of the message with a library of potentially sensitive terms to flag those message features that may be sensitive and should not be shared. The risk assessment engine 112 can output the flagged content to the sharing party for confirmation of whether the risk assessment engine 112 should allow the content to be shared.

### General

Numerous specific details are set forth herein to provide a thorough understanding of the claimed subject matter. However, those skilled in the art will understand that the claimed subject matter may be practiced without these specific details. In other instances, methods, apparatuses or systems that would be known by one of ordinary skill have not been described in detail so as not to obscure subject matter that may be claimed.

The system or systems discussed herein are not limited to any particular hardware architecture or configuration. A computing device can include any suitable arrangement of components that provide a result conditioned on one or more inputs. Suitable computing devices include multipurpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

1. A method comprising:
generating, by a computing device, relationships for a requirements document by analyzing elements of the requirements document and risks associated with the elements;
generating, by the computing device, a relationship interface that comprises the relationships for the requirements document; and
organizing, by the computing device, information relevant to the requirements document, but separate from the requirements document, into risk issues using the relationships interface.

2. The method of claim 1, further comprising:
identifying at least one resource for the information relevant to the requirements document; and
providing an interface between the at least one resource and a manager for the requirements document.

3. The method of claim 2, wherein generating, by the computing device, relationships for the requirements document by analyzing elements of the requirements document and risks associated with the elements comprises:
electronically extracting the elements of the requirements document;
matching an extracted element to a term or condition in a knowledge database comprising template requirements documents having a plurality of terms and a plurality of conditions;
matching the term or condition to at least one risk amount in a previous exposure database having a plurality of risk amounts, each associated with at least one term or condition of a historical requirements document;
determining an association of the term or condition to actual performance of a task associated with the term or condition in data about current performance of tasks for the requirements document; and
calculating a risk for the extracted element based on the risk amount and the actual performance.

4. The method of claim 3, wherein calculating the risk for the extracted element based on the risk amount and the actual performance comprises:
comparing the actual performance to expected performance according to the term or condition to determine actual variance;
determining a variance impact of the actual variance based on the extracted elements;
generating a future scenario for the variance impact; and
calculating the risk for the extracted element by combining the future scenario and the actual variance.

5. The method of claim 4, wherein generating the future scenario for the variance impact comprises:
determining a range of potential outcomes as a result of the actual variance based on statistical analysis of historical data about previous requirements documents having a comparable term or condition; and
determining a risk value based on the range of potential outcomes using the historical data.

6. The method of claim 1, wherein the relationships interface comprises representations of the risk issues,
wherein organizing, by the computing device, information relevant to the requirements document into risk issues using the relationships interface comprises:
identifying content in an electronic communication as information relevant to the requirements document by analyzing the content of the electronic communication; and
associating the content with at least one representation of a risk issue in the relationships interface.

7. The method of claim 2, wherein identifying the at least one resource for the content based on the risk issue and the element of the requirements document having the relationship to the risk issue comprises:
comparing the element to elements of other requirements documents to identify at least one similar requirements document to the requirements document;
determining a risk exposure for the element and the risk issue based on the at least one similar requirements document; and
identifying a type of resource for the content based on the risk exposure and the at least one similar requirements document.

8. The method of claim 2, wherein providing the interface between the at least one resource and the manager for the requirements document comprises:
identifying sensitive elements in the requirements document by comparing the elements to a sensitive attributes database, the sensitive attributes database comprising identifiers for sensitive elements;
removing the sensitive elements from the requirements document;
providing an interactive portal between the resource and the manager, the interactive portal allowing the resource to access the requirements document with sensitive elements removed and allowing communication between the resource and the manager;
analyzing communication to be shared between the resource and the manager to flag sensitive information included in the communication; and
outputting a notification about the sensitive information.

9. The method of claim 1, wherein the requirements document is a contract,
wherein the information relevant to the requirements document is an email message having content associated with a requirement in the contract.

10. A system, comprising:
a processor device; and
a tangible medium embodying code that is executable by the processor to cause the system to:
generate relationships for a requirements document by analyzing elements of the requirements document and risks associated with the elements;
generate a relationship interface that comprises the relationships for the requirements document; and
organize information relevant to the requirements document, but separate from the requirements document, into risk issues using the relationships interface.

11. The system of claim 10, wherein the code is executable by the processor to cause the system to:
identify at least one resource for the information relevant to the requirements document; and
provide an interface between the at least one resource and a manager for the requirements document.

12. The system of claim 11, wherein the code is executable by the processor to cause the system to generate relationships for the requirements document by analyzing elements of the requirements document and risks associated with the elements by:
electronically extracting the elements of the requirements document;
matching an extracted element to a term or condition in a knowledge database comprising template requirements documents having a plurality of terms and a plurality of conditions;
matching the term or condition to at least one risk amount in a previous exposure database having a plurality of risk amounts, each associated with at least one term or condition of a historical requirements document;
determining an association of the term or condition to actual performance of a task associated with the term or condition in data about current performance of tasks for the requirements document; and
calculating a risk for the extracted element based on the risk amount and the actual performance.

13. The system of claim 12, wherein the code is executable by the processor to cause the system to calculate the risk for the extracted element based on the risk amount and the actual performance by:
comparing the actual performance to expected performance according to the term or condition to determine actual variance;
determining a variance impact of the actual variance based on the extracted elements;
generating a future scenario for the variance impact; and
calculating the risk for the extracted element by combining the future scenario and the actual variance.

14. The system of claim 13, wherein the code is executable by the processor to cause the system to generate the future scenario for the variance impact by:
determining a range of potential outcomes as a result of the actual variance based on statistical analysis of historical data about previous requirements documents having a comparable term or condition; and
determining a risk value based on the range of potential outcomes using the historical data.

15. The system of claim 10, wherein the relationships interface is configured to include representations of the risk issues,
wherein the code is executable by the processor to cause the system to organize information relevant to the requirements document into risk issues using the relationships interface by:
identifying content in an electronic communication as information relevant to the requirements document by analyzing the content of the electronic communication; and
associating the content with at least one representation of a risk issue in the relationships interface.

16. The system of claim 11, wherein the code is executable by the processor to cause the system to identify the at least one resource for the content based on the risk issue and the element of the requirements document having the relationship to the risk issue by:
comparing the element to elements of other requirements documents to identify at least one similar requirements document to the requirements document;
determining a risk exposure for the element and the risk issue based on the at least one similar requirements document; and
identifying a type of resource for the content based on the risk exposure and the at least one similar requirements document.

17. The system of claim 11, wherein the code is executable by the processor to cause the system to provide the interface between the at least one resource and the manager for the requirements document by:
identifying sensitive elements in the requirements document by comparing the elements to a sensitive attributes database, the sensitive attributes database comprising identifiers for sensitive elements;
removing the sensitive elements from the requirements document;
providing an interactive portal between the resource and the manager, the interactive portal allowing the resource to access the requirements document with sensitive elements removed and allowing communication between the resource and the manager;
analyzing communication to be shared between the resource and the manager to flag sensitive information included in the communication; and
outputting a notification about the sensitive information.

18. The system of claim 10, wherein the requirements document is a contract,
wherein the information relevant to the requirements document is an email message configured to have content associated with a requirement in the contract.

19. A tangible computer-readable medium comprising program code that is executable by a processor to perform actions, the program code comprising:
code for extracting elements of a requirements document;
code for relating at least some extracted elements together based on meaning of the extracted elements to generate relationships between the at least some extracted elements; and
code for storing the extracted elements and the relationships.

20. The tangible computer-readable medium of claim 19, further comprising:
code for generating a relationship interface that comprises the relationships for the requirements document;
code for organizing information relevant to the requirements document, but separate from the requirements document, into risk issues using the relationships interface;
code for identifying at least one resource for the information relevant to the requirements document; and
code for providing an interface between the at least one resource and a manager for the requirements document.
